(19) United States
(12) Patent Application Publication
(10) Pub. No.: US 2004/0230694 A1
(43) Pub. Date: Nov. 18, 2004

(54) Method and device for data transmission

(75) Inventors: Jurgen Baus, Eggenstein-Leopoldshafen (DE); Rolf-Dieter Pavlik, Erlangen (DE); Gernot Rossi, Simmelsdorf (DE); Frank Volkmann, Nurnberg (DE)

Correspondence Address: HENRY M FEIEREISEN, LLC, 350 FIFTH AVENUE, SUITE 4714, NEW YORK, NY, 10118, US

(73) Assignee: SIEMENS AKTIENGESELLSCHAFT, Munchen (DE)

(21) Appl. No.: 10/822,227

(22) Filed: Apr. 9, 2004

(30) Foreign Application Priority Data
Apr. 9, 2003 (DE) 103 16 288.7

(51) Int. Cl. G06F 15/16

(52) U.S. Cl. 709/230; 709/218

(57) ABSTRACT

A data transmission device for allowing access from a remote unit to at least one automation device via a standard browser includes a data conversion unit connected between the remote unit and an automation device. The data conversion unit is capable of converting data between a first communication protocol and a second communication protocol. The data are exchanged between an automation device and the data conversion unit and between the automation devices themselves by using the first communication protocol. The data are then exchanged between the data conversion unit and the remote unit according to a second communication protocol.

### CROSS-REFERENCES TO RELATED APPLICATIONS

This application claims the priority of German Patent Application, Serial No. 103 16 288.7, filed Apr. 9, 2003, pursuant to 35 U.S.C. 119(a)-(d), the disclosure of which is incorporated herein by reference.

### BACKGROUND OF THE INVENTION

The present invention relates to a method and device for data transmission, in particular for data transmission in environments using different transmission protocols.

Improvements in the automation technology increasingly demand access to automation devices from a remote unit via a standard browser. A standard browser can include, for example, the Internet Explorer™, while the automation device can be a stored-program controller (SPC). Web servers integrated in an automation environment are described, for example, in U.S. Pat. No. 6,282,454, U.S. Pat. No. 6,061,603, or U.S. Pat. No. 5,805,442. The Web servers disclosed therein, however, operate with manufacturer-specific our product-specific protocols and do not allow a standard browser to directly access automation devices.

It would therefore be desirable and advantageous to provide a novel device for data transmission and a method for using such device, which obviates prior art shortcomings and is able to allow standard browsers to seamlessly communicate with automation devices.

### SUMMARY OF THE INVENTION

According to one aspect of the present invention, a data transmission device for accessing from a remote unit at least one automation device via a standard browser includes a data conversion unit connected between the remote unit and at least one automation device and configured to convert data between a first communication protocol and a second communication protocol. Data are exchanged between an automation device and the data conversion unit and between different automation devices by using the first communication protocol, whereas data are exchanged between the data conversion unit and the remote unit according to a second communication protocol.

The device according to the invention for data transmission allows access to an automation device from a remote unit by a standard web server. This approach obviates the need to install a Web server on the automation devices or automation units. The device of the present invention, on one hand, meets the requirements for a communication protocol in the automation environment, and, on the other hand, enables a convenient conversion of the communication protocol used in the automation environment to the requirements of the Internet communication protocol.

According to another aspect of the invention, a method for data transmission to access from a remote unit via a standard browser at least one automation device, includes the steps of transmitting the data between the remote unit and an automation device by connecting a data conversion unit therebetween, exchanging the data between an automation device and the data conversion unit and between the automation devices themselves according to a first communication protocol, exchanging the data between the data conversion unit and the remote unit according to a second communication protocol, and converting with the data conversion unit the data according to the first communication protocol into the data according to the second communication protocol.

The device and method of the invention may include one or more of the following features. A data processing unit, which may also include a web server, can be connected between the data conversion unit and the remote unit, so that the data conversion unit can exchange data with the remote unit via the data processing unit. In addition, an operating and monitoring device can be connected between the data conversion unit and the data processing unit. The data conversion unit may include a communication DLL for converting the data that are transmitted from the at least one automation device according to the first communication protocol for further processing by the data processing unit or optionally the operating and monitoring device. The data processing unit exchanges data with the remote unit according to the second communication protocol. The data conversion unit can be operatively connected with a data processing unit and the remote unit, so that the data conversion unit can be configured as an expansion module of a standard browser installed on the data processing unit. The expansion module can be configured so as to be loadable via the Internet and can be coupled to the standard browser.

The data conversion unit can be operatively connected with a data processing unit and the remote unit, so that the data conversion unit can be configured as an application software module installed on the data processing unit. The application software module can implemented as a database program, an Enterprise Resource Planning (ERP) program and/or a data history logging program.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a schematic high-level block diagram of a device for data transmission in accordance with the present invention;

FIG. 2 is a schematic detailed block diagram of a first embodiment of the device of FIG. 1;

FIG. 3 is a schematic detailed block diagram of a second embodiment of the device of FIG. 1;

FIG. 4 is a schematic detailed block diagram of a third embodiment of the device of FIG. 1; and

FIG. 5 is a schematic detailed block diagram of a fourth embodiment of the device of FIG. 1;

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

This is one of two applications both filed on the same day. Both applications deal with related inventions. They are commonly owned and have the same inventive entity. Both applications are unique, but incorporate the other by reference. Accordingly, the following U.S. patent application is hereby expressly incorporated by reference: “METHOD AND DEVICE FOR DATA TRANSMISSION”.

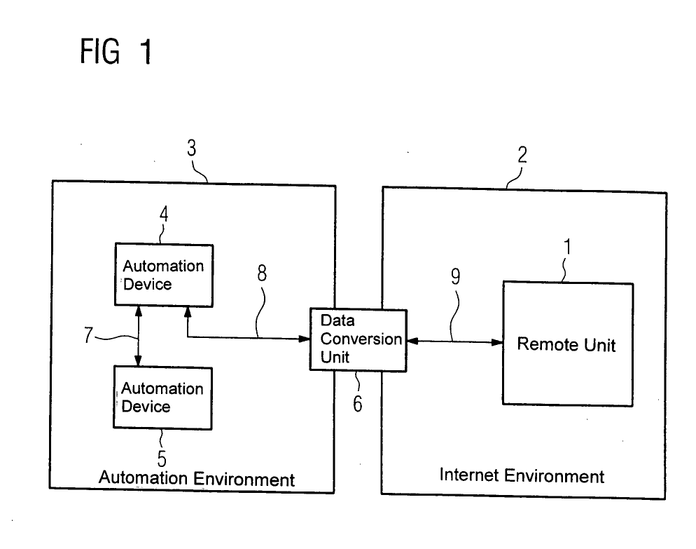

Turning now to the drawing, and in particular to FIG. 1, there is shown a schematic high-level block diagram of the device according to the invention. FIG. 1 shows a remote unit 1, associated with an Internet environment 2. In the depicted exemplary embodiment, two automation units 4, 5 are associated with an automation environment 3, wherein the two automation units 4, 5 in the depicted embodiments are implemented as stored-program controllers (SPC). However, the automation devices 4, 5 can also include CNC units, drives or another type of unit suitable to automate industrial processes.

According to the present invention, the remote unit 1 accesses the automation devices 4, 5 via a standard browser, for example the Internet Explorer™, and exchanges data with the automation units 4, 5. Standard browsers may also includes Netscape, Mozilla, Opera, and the like. A data conversion unit 6, also referred to as an agent, is connected between the remote unit 1 and the automation devices 4, 5. The data conversion unit 6 therefore enables data exchange between the automation units 4, 5 associated with the automation environment 3 and the remote unit 1 associated with the Internet environment 2.

The automation devices 4, 5 associated with the automation environment 3 exchange, on one hand, data with each other, as indicated by the arrow 7, and, on the other hand, exchange data with the data conversion unit 6, as indicated by the arrow 8. The data exchange indicated by the arrows 7 and 8, i.e., the data exchange between the units associated with the automation environment 3, is implemented with a first communication protocol.

This first communication protocol is a time-optimized transmission protocol with a high throughput rate for useful data and a low protocol overhead. The first communication protocol is capable of transmitting markup data as well as binary data. When the data transmission between two devices or units begins, for example, when data are transmitted at the beginning of the transmission in the depicted embodiment of FIG. 1 (indicated by the arrows 7 and 8, respectively), the units 4 and 5, or 4 and 6, decide automatically, if a markup data transmission protocol or a binary data transmission protocol are is used in the data exchange according to the first communication protocol.

It should be pointed out that the markup data transmission and the binary data transmission are configured in the first communication protocol so that fast mapping between the markup data transmission and the binary data transmission is enabled. This can be achieved because the binary data transmission differs from the markup data transmission only by the so-called syntax. In all other aspects, the two data transmission types within the first communication protocol are identical. The units participating in the data exchange, i.e., the transmitter and the receiver, therefore agree at the start of the data transmission if the binary or a text-based data transport is selected.

It should be noted that binary data transmission is preferred if data are to be exchanged between the two automation devices 4, 5, because binary data transmission accelerates the data exchange and this plane does not require conversion into another data transmission protocol. However, if data are to be exchanged between the automation device 4 and the data conversion unit 6, then the markup data transmission is preferred within the first communication protocol. This makes it easier for the data conversion device 6 to convert the data to a second communication protocol used for data exchange between the data conversion unit 6 as a remote unit 1, as indicated by the arrow 9. The second communication protocol, which is used for data transmission between the data conversion unit 6 and the remote unit 1, can be a standard protocol for a Web-based data transport, preferably an HTTP protocol.

It should be noted in the context of the first communication protocol, which is used, on one hand, for data exchange among the automation devices 4, 5 and, on the other hand, for data exchange between the automation device 4 and the data conversion unit 6, that both the markup data transmission and the binary data transmission are instruction-based. Accordingly, both the markup data transmission and the binary data transmission are extendable and therefore upwards compatible. In order to ensure clarity throughout the disclosure, the term “instruction-based” means that during data transmission, a sequence of instructions is transmitted first, with the parameters of the instructions being transmitted at a later time. In binary data transmissions, the instruction is a bit sequence, in the markup data transmission the instruction is a markup tag.

It is also desirable with the present invention to transmit quality data in conjunction with the first communication protocol. The transmission of quality data as a component of the communication protocol is proposed herein for the first time and has not been reported in publicly accessible publications. Quality data are transmitted in both markup data transmission and in binary data transmission using the first communication protocol. Quality data are defined as information in addition to the data to be transmitted and can be, for example, values for the data to be transmitted and/or information about the significance and/or urgency of the data. Urgency of information is meant to indicate how quickly data have to be available in the remote unit 1.

These quality data are used, inter alia, by the data conversion unit to decide how to perform the data transmission between the data conversion unit 6 and the remote unit 1. For example, a so-called simple Polling or a so-called endless HTML page or a bidirectional HTTP communication can be used, depending on the importance and/or urgency of the data that are to be transmitted with the second communication protocol, which allows data transmission between the data conversion unit 6 and the remote unit 1. The aforementioned transmission protocols are familiar to a person skilled in the art. A bidirectional HTTP communication is described, for example, in German Pat. No. DE 199 04 331 C1. The data conversion unit 6 therefore decides automatically based on the transmitted quality data which of the afore-described transmission protocols to use. The quality data therefore represent a decision aid for the data conversion unit 6.

As mentioned above, the data transmission is time-optimized and readily expandable. The bidirectional data transmission in the automation environment 3 can be easily converted to a unidirectional data transmission in the Internet environment. In addition, data transmission can occur in real time. Real-time capability is essentially a consequence of providing the binary data transmission in the first communication protocol. The data transmission can be operated in parallel with a so-called Hard-Real-Time-Ethernet or a so-called Soft-Real-Time-Ethernet. This property is inherent in the features described above.

It should also be noted that in the first communication protocol, which is provided for data transmission among the automation devices 4, 5 themselves and the data transmission between the automation devices 4, 5 and the data conversion unit 6, that safety mechanisms for encrypting, authentication and access control can also be integrated. These safety mechanisms can be implemented in both markup data transmission and binary data transmission as markup instructions and binary instructions, respectively.

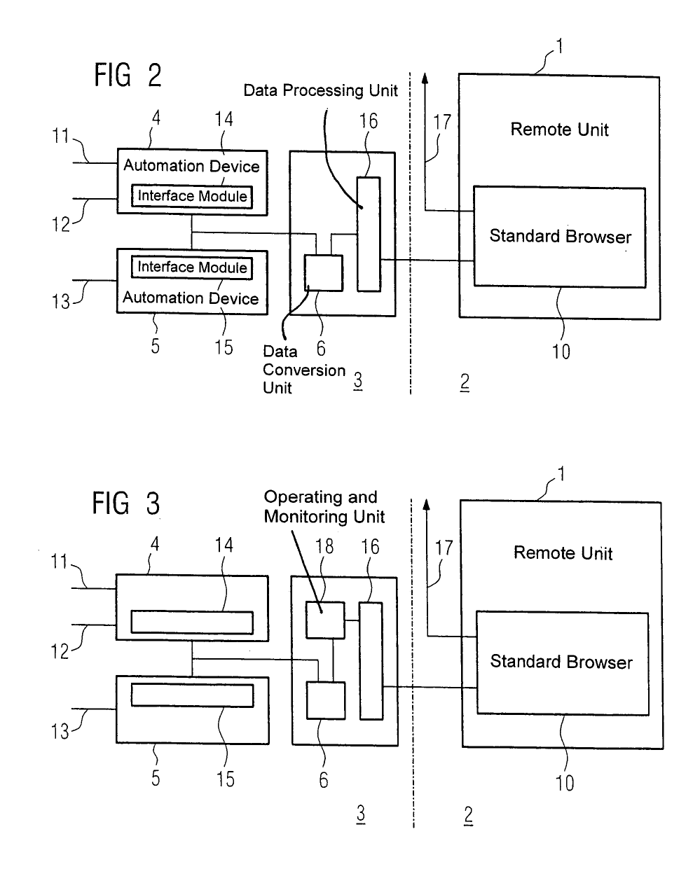

In the following, four embodiments of the device of the invention for data transmission will be described in more detail with reference to FIGS. 2 to 5, wherein all four embodiments employ the principle described above with reference to FIG. 1. Parts corresponding with those in FIG. 1 are denoted by identical reference numerals and not explained again. The description below will center on the differences between the embodiments.

FIG. 2 shows an embodiment with two automation devices 4 and 5, whereby the two automation devices 4 and 5 are adapted to exchange data with a remote unit 1. The two automation devices 4 and 5 are associated with the automation environment 3, whereas the remote unit is associated with an Internet environment 2. The automation environment 3 can also be viewed as an intranet environment.

As shown in FIG. 2, a standard browser 10 is installed on the remote unit 1. Data are to be exchanged between the remote unit 1 and the automation devices 4, 5 via the standard browser 10, whereby the automation devices 4 and 5 in the embodiment of FIG. 2 are implemented as process control components which exchange data with downstream components via input and/or output connections 11, 12 and 13. An interface module 14 and 15, respectively, is associated with each automation device 4 and 5 for providing the data from the automation devices 4, 5 in the first communication protocol.

According to FIG. 2, a data conversion unit 6 is connected between the automation devices 4 and 5 and the remote unit 1. The data conversion unit 6 is associated with a data processing unit 16. In the depicted embodiment, the data processing unit 16 is implemented as a Web server. Accordingly, the automation devices 4, 5 exchange data according to the first communication protocol with each other and, on the other hand, with the data conversion unit 6. The data processing unit 16, which is implemented as a Web server, exchanges the same data with the remote unit 1 and/or the standard browser 10 according to the second communication protocol. The data conversion from the first communication protocol to the second communication protocol is performed by the data conversion unit 6 which in the embodiment depicted in FIG. 2 provides a communication DLL. The communication DLL can be, for example, a so-called ISAPI-DLL (Internet Services Application Programmers Interface-DLL) or a CGI (Common Gateway Interface). According to FIG. 2, the data conversion unit 6 can be accessed directly from the Internet and the interconnected Web server 16. So-called SSI-pages or ASP-pages can also be accessed. The arrow 17 indicates that other Internet services can also be accessible.

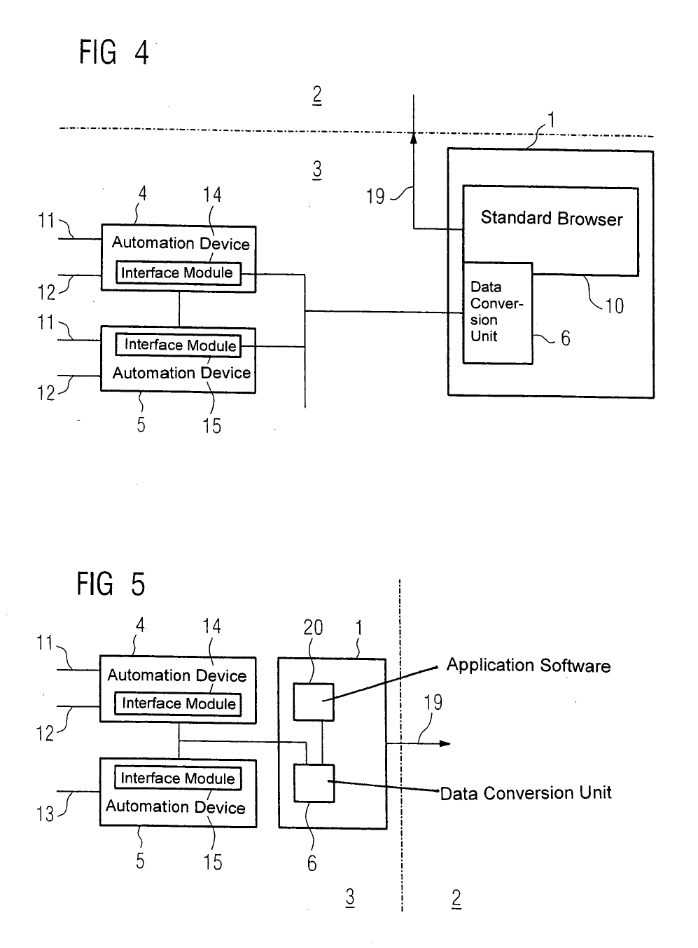

The embodiment of FIG. 3 corresponds essentially to the embodiment of FIG. 2. The same components and modules have here again the same reference characters. The embodiment of FIG. 3 is different from the embodiment of FIG. 2 essentially in that the data conversion unit 6 does not directly exchange data with the data processing unit 16 implemented as a Web server, but is instead connected via an intervening so-called operating and monitoring unit 18. The operating and monitoring unit 18 can be, for example, a WinCC-system. In this case, the data conversion unit 6 provides as communication DLL for the operating and monitoring unit 18 a so-called channel DLL, which enables the operating and monitoring unit 18 to directly graphically process the data transmitted from the automation devices 4 and 5. In the embodiment of FIG. 2, on the other hand, the data are transmitted to the standard browser 10 of the remote unit 1 without graphic processing. In the embodiment of FIG. 4, the standard browser 10 can graphically process the data transmitted from the automation devices 4 and 5.

FIG. 4 shows a third embodiment of the data transmission device according to the invention. In the embodiment depicted in FIG. 4, data are also to be exchanged between automation devices 4 and 5 and a remote unit 1. Again, interface modules 14 and 15 are associated with the automation devices 4 and 5 for transmitting the data provided by the automation devices 4 and 5 in the first communication protocol. Also, a standard browser 10 is installed on the remote unit 1. Unlike the embodiment depicted in FIGS. 2 and 3, the remote unit 1 is not associated with the Internet environment 2, but is like the automation devices 4 and 5 associated instead with the automation environment 3. As indicated by the arrow 19 in FIG. 4, a connection to or a data exchange with the Internet environment 2 is possible. In the embodiment of FIG. 4, the data conversion unit 6 is implemented as an expansion module for the standard browser 10. The data conversion unit 6 together with the standard browser 10 are installed on the remote unit 1 associated with the automation environment 3. The remote unit 1 is implemented as a workstation or as another computer. The automation devices 4 and 5 then exchange data with the data conversion unit 6 in the first communication protocol. The data conversion unit 6, which is implemented as an expansion module for the standard browser 10, is here preferably implemented as a protocol converter or data processing device. This can be achieved in Java or ActiveX. The data conversion unit 6 in the embodiment depicted in FIG. 4 it is therefore implemented as a software expansion module which converts the data provided in the first communication protocol by the automation devices 4 and 5 into the second communication protocol that can be process by the standard browser. The second communication protocol is hereby also an HTTP protocol.

It should be noted here with reference to FIG. 4, that the data conversion unit 6 implemented as a software expansion module can be provided by any Web server and downloaded from the Internet. The expansion module downloaded from the Internet can then be coupled to the standard browser 10. For example, if the remote unit 6 is a laptop computer on which typically only the standard browser 10 is installed, then the expansion module can be downloaded from the Internet and coupled automatically to the standard browser 10. This allows easy access, without noticeable administrative overhead, to the data provided by the automation devices 4 and 5.

FIG. 5 shows another embodiment of the device according to the invention. In the embodiment depicted in FIG. 5, the data conversion unit 6 is again installed on a remote unit 1 which is associated to the automation environment 3. In the exemplary embodiment depicted in FIG. 5, the data conversion unit 6 is implemented as an application software module 20 that is installed on the remote unit 1. The application software 20 can be, for example, a database program, an enterprise resource planning (ERP) program, or a data history logging program. In the embodiment of FIG. 5, the data conversion unit 6 is therefore also implemented as a software expansion module, however unlike the embodiment of FIG. 4, for a concrete application software. In this way, it is possible to provide the data provided by the automation devices 4 and 5 directly to the application software 20.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A data transmission device for accessing from a remote unit at least one automation device via a standard browser, comprising a data conversion unit connected between the remote unit and at least one automation device and configured to convert data between a first communication protocol and a second communication protocol, wherein the data are exchanged between the at least one automation device and the data conversion unit and between the automation devices by using the first communication protocol, and wherein the data are exchanged between the data conversion unit and the remote unit according to a second communication protocol.

2. The device of claim 1, and further comprising a data processing unit connected between the data conversion unit and the remote unit, so that the data conversion unit exchanges data with the remote unit via the data processing unit.

3. The device of claim 2, wherein the data processing unit includes a web server.

4. The device of claim 2, and further including an operating and monitoring device connected between the data conversion unit and the data processing unit.

5. The device of claim 2, wherein the data conversion unit comprises a communication DLL for converting the data that are transmitted from the at least one automation device according to the first communication protocol for further processing by the data processing unit, wherein the data processing unit exchanges data with the remote unit according to the second communication protocol.

6. The device of claim 4, wherein the data conversion unit comprises a communication DLL for converting the data that are transmitted from the at least one automation device according to the first communication protocol for further processing by the operating and monitoring device, wherein the data processing unit exchanges data with the remote unit according to the second communication protocol.

7. The device of claim 2, and further comprising a data processing unit, wherein the data conversion unit is operatively connected with the data processing unit and the remote unit, so that the data conversion unit is configured as an expansion module of a standard browser installed on the data processing unit.

8. The device of claim 7, wherein the expansion module is configured to be loadable via the Internet and couplable to the standard browser.

9. The device of claim 1, and further comprising a data processing unit, wherein the data conversion unit is operatively connected with the data processing unit and the remote unit, so that the data conversion unit is configured as an application software module installed on the data processing unit.

10. The device of claim 9, wherein the application software module is implemented as one of a database program, an Enterprise Resource Planning (ERP) program or a data history logging program.

11. A method for data transmission to access from a remote unit via a standard browser at least one automation device, comprising the steps of:
a) transmitting the data between the remote unit and the at least one automation device by connecting a data conversion unit therebetween;
b) exchanging the data between the at least one automation device and the data conversion unit and between the automation devices according to a first communication protocol;
c) exchanging the data between the data conversion unit and the remote unit according to a second communication protocol; and
d) causing the data conversion unit to convert the data according to the first communication protocol into the data according to the second communication protocol.
